(19) United States
(12) Patent Application Publication
(10) Pub. No.: US 2002/0192538 A1
(43) Pub. Date: Dec. 19, 2002

(54) Current collector for fuel cell and method of producing the same

(75) Inventors: Ichiro Tanahashi, Osaka (JP); Masato Hosaka, Osaka (JP)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: MATSUSHITA ELECTRIC INDUSTRIAL CO., LTD.

(21) Appl. No.: 10/157,287

(22) Filed: May 29, 2002

(30) Foreign Application Priority Data
May 30, 2001 (JP) JP2001-162787

(51) Int. Cl. H01M 4/96; H01M 4/88

(52) U.S. Cl. 429/44; 502/101

(57) ABSTRACT

A simple and inexpensive production method is devised to provide a current collector for a fuel cell having excellent gas permeability and mechanical strength, small electrical resistance and improved surface water-repellency. The current collector is produced by causing a sheet comprising a carbon fiber and a pulp to carry fluorocarbon resin particles and carbon particles partially or wholly or by making a sheet from a carbon fiber and a pulp that are caused to carry fluorocarbon resin particles and carbon particles partially or wholly.

### BACKGROUND OF THE INVENTION

The present invention relates to a current collector for fuel cells used for small-sized decentralized power sources, automobiles or the like, and a method for producing the same. More particularly, the present invention relates to a current collector which excels in current collecting ability and gas dispersion/permeability and can be produced inexpensively.

A fuel cell is an apparatus which generates electric power and heat simultaneously by reacting a fuel gas containing hydrogen with an oxidant gas containing oxygen such as air electrochemically. At present, fuel cells are under development as relatively small-sized power generating plants for buildings, factories or the like. However, in order to apply fuel cells to on-board power sources for automobiles and small-sized, mobile power sources, they need to be downsized.

Fuel cells are classified into several types: solid polymer type, phosphoric acid type, molten carbonate type, solid oxide type, etc. A conventional fuel cell will be described in the following, taking a solid polymer electrolyte fuel cell as an example. FIG. 1 is a schematic cross-sectional view of a unit cell having a fundamental structure. An anode catalyst layer 12 and a cathode catalyst layer 13 are disposed on both sides, respectively, of a polymer electrolyte membrane 11 capable of selectively transporting hydrogen ions. Outside these catalyst layers are disposed current collectors 14 and 15 having both gas permeability and electronic conductivity. The current collectors are composed of, for example, carbon paper subjected to a water-repelling. treatment. Outside the current collectors 14 and 15 are disposed separators 16 and 17. The separators 16 and 17 have a fuel gas flow channel 18 and an oxidant gas flow channel 19 on their sides in contact with the current collector 14 and 15, respectively. On the other sides are formed cooling water flow channels 20 and 21, respectively. Further, gaskets 22 and 23 are disposed on outer peripheries of the current collectors 14 and 15, respectively, to seal gas-circulating portions.

Among these components of the fuel cell, the current collector generally plays an important role, since it allows the fuel gas and the oxidant gas to disperse effectively to the surface of catalyst to cause electrochemical reactions on the catalyst and transmits electricity generated within the unit cell of the fuel cell to outside. It is noted that the fuel gas and the oxidant gas may contain steam.

A conventional current collector is produced, for example, by binding a carbon fiber with a binder into a sheet and baking the sheet at high temperatures to graphitize the carbon fiber. Another current collector is, for example, a porous carbon plate produced by binding a carbon short fiber with carbon, which is disclosed in the Japanese Laid-Open Patent Publication No. Hei 6-20710 and No. Hei 7-326362. However, production of such current collectors are quite costly since it needs mixing of a carbon fiber or carbon fiber precursor with a resin and baking the resultant mixture in an inert atmosphere at high temperatures. Further, in such a production method, it is impossible to control the repellency of the resultant current collector to steam and generated water.

In order to reduce the production cost, the Japanese Laid-Open Patent Publication No. Hei 7-105957 and No. Hei 8-7897 disclose a method in which a carbon fiber aggregate in paper form is used as the current collector. Since this method does not have a process for binding carbon or the like with a binder, it needs pressurization to lower the electrical resistance in the direction of the thickness of the current collector. Also, in this method, the carbon fiber aggregate is quite difficult to handle in producing the current collector. Further, it is also impossible to control the repellency of the resultant current collector to steam and generated water.

The Japanese Laid-Open Patent Publication No. Hei 10-162838 discloses a current collector in paper form or felt form produced by binding a short carbon fiber with a binder. In such a technique, since the binder is generally insulating, it is not possible to lower the electrical resistance of the current collector. In addition, it is also impossible to control the repellency of the resultant current collector to steam and generated water.

The Japanese Laid-Open Patent Publication No. Hei 7-105957 discloses a current collector composed of a carbon fiber in fabric form that is hydrophilic or water-repellent. Although this current collector needs no binder, it is quite costly to form carbon fibers into a fabric form. Also, the presence of a number of pores among the fibers results in large contact resistance of the current collector.

As described above, in order to realize a small-sized fuel cell with high performance, the performance of the current collector, which has a major influence on the characteristics of the fuel cell, must be enhanced while the production cost is reduced.

In addition, it is important for the current collector for fuel cells to have excellent mechanical strength, high conductivity, chemical stability with respect to the fuel gas and oxidant gas, and ability to disperse steam effectively. Furthermore, the current collector needs to be water-repellent enough to promptly discharge steam brought by the fuel gas and oxidant gas and water generated in electrode reactions. Such water-repellency makes it possible to prevent flooding of water which will adversely affect cell characteristics and reliability.

For an actual use of the fuel cell, the above-described unit cells are stacked in dozens of layers to form a cell stack. In stacking, it is important to secure sufficient adhesion between the unit cells. If the unit cells are stacked without adhering to each other closely, the contact resistance between the unit cells increases to cause an increase in internal resistance of the cell stack, thereby impairing the cell performance significantly. Also, since the unit cells are under pressure, cracks may occur to break or damage the current collector. Therefore, controlling the material strength, dimension accuracy and flatness of the current collector is of great importance. Further, the conventional production methods of the current collector are quite costly.

Therefore, an object of the present invention is to solve the above-described problems of the prior art and provide a current collector for a fuel cell having low electrical resistance, excellent mechanical strength, excellent flatness and high performance. Another object of the present invention is to provide a method of producing a current collector for a fuel cell which does not need a baking process at high temperatures and is therefore inexpensive.

### BRIEF SUMMARY OF THE INVENTION

The present invention provides a current collector for a fuel cell which is composed of a sheet comprising a carbon fiber that is at least partially water-repellent and a pulp that is at least partially conductive and water-repellent.

The sheet preferably has a weight in a range of 10 to 300 g/m².

The carbon fiber is preferably a polyacrylonitrile-type, phenol-type, pitch-type, or rayon-type carbon fiber having a length of 2 to 10 mm, a diameter of 20 Am or less, a volume resistivity of 500 μΩ·m or less.

The present invention also provides a method of producing the aforementioned current collector for a fuel cell which is composed of a sheet comprising a carbon fiber that is at least partially water-repellent and a pulp that is at least partially conductive and water-repellent.

A first method of producing the current collector in accordance with the present invention comprises the steps of (1) mixing a carbon fiber and a pulp and forming the mixture into a sheet and (2) causing the sheet to carry fluorocarbon resin particles and carbon particles at least partially.

A second method of producing the current collector in accordance with the present invention comprises the steps of (1) causing a carbon fiber and a pulp to carry fluorocarbon resin particles and carbon particles at least partially and (2) mixing the carbon fiber and pulp carrying the fluorocarbon resin particles and the carbon particles and forming the mixture into a sheet.

These production methods preferably comprise the step of applying pressure to the sheet to heighten the density of the sheet.

Also, these production methods preferably comprise the step of subjecting the sheet to ultraviolet rays radiation, ozone treatment or plasma treatment.

Especially, the first production method preferably comprises the step of subjecting the carbon fiber and the pulp to ultraviolet rays radiation, ozone treatment or plasma treatment before mixing them and forming the mixture into a sheet.

The second production method preferably comprises the step of subjecting the carbon fiber and the pulp to ultraviolet rays radiation, ozone treatment or plasma treatment before causing them to carry the fluorocarbon resin particles and the carbon particles.

The present invention also provides a membrane electrode assembly comprising a polymer electrolyte membrane, a catalyst layer disposed on each side of the polymer electrolyte membrane, and the aforementioned current collector disposed outside the catalyst layer.

The present invention further provides a fuel cell comprising the aforementioned membrane electrode assembly.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic cross-sectional view illustrating the structure of a fuel cell.

### DETAILED DESCRIPTION OF THE INVENTION

A current collector for a fuel cell in accordance with the present invention is composed of a sheet comprising a carbon fiber that is partially or wholly water-repellent and a pulp that is partially or wholly conductive and water-repellent.

In the current collector in accordance with the present invention, the mixing ratio of carbon fiber to pulp is desirably 60-95 wt % (carbon fiber) to 5-40 wt % (pulp). When the ratio of pulp is less than 5 wt %, the strength of the current collector decreases, while when it is more than 40 wt %, the electrical resistance of the current collector increases. The mixing ratio is more desirably 80-90 wt % (carbon fiber) to 10-20 wt % (pulp).

The amount of carbon particles carried is desirably 2-40 wt % of the total weight of carbon fiber and pulp. When the amount is less than 2 wt %, the electrical resistance increases, while when it is more than 40 wt %, the binding strength of the sheet and carbon particles decreases. When the current collector has insufficient strength, it may become cracked during fabrication or operation of the fuel cell, so that the function of the current collector may be impaired. The amount of carbon particles carried is more desirably 5-20 wt % of the total weight of carbon fiber and pulp.

As the carbon fiber, it is possible to use a carbon fiber obtained by carbonizing or graphitizing a polyacrylonitrile-type fiber, pitch-type fiber, rayon-type fiber, or phenol-type fiber in an inert atmosphere. Further, a fiber graphitized by heat treatment at high temperatures is desirable since it has superior conductivity and mechanical strength.

The length of the carbon fiber is desirably 2 to 10 mm. When the length is more than 10 mm, the carbon fiber is not dispersed sufficiently when mixed and formed into a sheet, so that the resultant current collector becomes inhomogeneous. Also, when the length is less than 2 mm, the mechanical strength of the resultant current collector decreases and the density thereof becomes difficult to control. The length of the carbon fiber is more desirably 3 to 6 mm.

The diameter of the carbon fiber is desirably 20 μm or less. When the diameter is more than 20 μm, mixing of the carbon fiber with pulp and dispersion of the carbon fiber become difficult. The diameter of the carbon fiber is more desirably 5 to 10 μm.

The volume resistivity of the carbon fiber is preferably 500 μΩ·m or less. When it is more than 500 m, the resistance of the resultant current collector increases, resulting in deterioration of cell characteristics.

As the pulp, it is possible to use natural pulp such as cotton pulp, hemp pulp, Manila hemp pulp or wood pulp, artificial pulp (fiber) such as polyester, nylon, polyethylene or polypropylene, a mixture of natural pulp and artificial pulp, or the like. It is preferable to sufficiently beat the pulp before using it since this allows the pulp to have strong binding ability even in a small amount.

The carbon fiber and pulp are mixed and formed into a sheet using a sizing agent. Examples of the sizing agent include conventional glue, starch, polyvinyl alcohol and rosin size.

As the carbon particles, it is preferable to use submicron graphite particles applied to the conductive film inside a cathode-ray tube. A dispersion obtained by dispersing carbon particles in water for stabilization may be used. Examples of the dispersion include Aquadag manufactured by Acheson Japan Ltd. and Hitasole manufactured by Hitachi Chemical Co., Ltd.

The method of producing a current collector in accordance with the present invention has a general step of making paper. This step may be performed manually or mechanically.

In the production method of the present invention, ultraviolet rays radiation, ozone treatment or plasma treatment is applied to the current collector to decompose functional groups on the surface of the current collector, thereby enabling an improvement of the water-repellency of the current collector. Further, such treatment improves the mechanical strength of the current collector even when a small amount of pulp is used.

The ultraviolet rays radiation and ozone treatment use a light source. The light source is preferably a high-pressure mercury lamp, low-pressure mercury lamp, xenon lamp or the like since effective emission of ultraviolet rays and ozone is possible.

The plasma treatment uses a gas, and the gas may be an argon gas, oxygen gas, nitrogen gas or a mixture of these gases. The plasma treatment removes oxides and impurities on the surface of the current collector and allows formation of hydrogen bond. Further, this treatment improves interfacial adhesion of the carbon fiber and pulp to the fluorocarbon resin particles and carbon particles.

In the followings, the present invention will be described in detail with reference to examples. These examples, however, are not to be construed as limiting in any way the present invention.

### EXAMPLES 1-20

In these examples, a carbon fiber and a pulp were caused to carry fluorocarbon resin particles and carbon particles before they were mixed and formed into a sheet, to produce a current collector.

As shown in Table 1, various kinds of carbon fibers were used. A carbon fiber and Manila hemp pulp were mixed at various ratios and the resultant mixture was formed into a sheet to produce a current collector in accordance with the present invention. The carbon fibers used in these examples had a length of 6 mm, a volume resistivity of 200 μΩ·m and a diameter of 8 μm. In forming the sheet, polyvinyl alcohol was added as a sizing agent in an amount corresponding to 1 wt % of the total weight of the aforementioned mixture in any of these examples.

In order to make the whole surface of the carbon fiber and the pulp water-repellent and conductive, the carbon fiber or the pulp was immersed into a colloidal carbon dispersion having a specific gravity of 1.15 and containing 1 wt % polytetrafluoroethylene dispersion (POLYFLON D-1, manufactured by DAIKIN INDUSTRIES LTD.), was dried in the air at room temperature for 1 hour and at 100° C. for 1 hour, and was heated in the air at 200° C. for 1 hour.

In order to make the surface of the carbon fiber and the pulp partially water-repellent and conductive, the carbon fiber or the pulp was sprayed with a colloidal carbon dispersion having a specific gravity of 1.15 and containing 0.1 wt % polytetrafluoroethylene dispersion (POLYFLON D-1, manufactured by DAIKIN INDUSTRIES LTD.), was dried in the air at room temperature for 1 hour and at 100° C. for 1 hour, and was heated in the air at 200° C. for 1 hour. At this time, 30 to 80% of the surface of the resultant carbon fiber or pulp was covered with carbon particles and fluorocarbon resin particles. In other words, the ratio of covered area of carbon fiber or pulp was 30 to 80%. In these examples, the resistance value of the current collector was measured in conformity with JIS H0602.

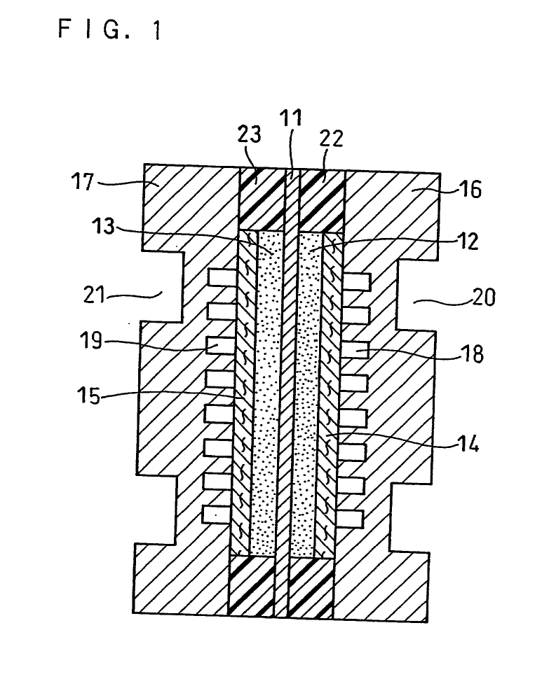

Using current collectors of Examples 1 to 20 produced in the above manner, fuel cells having a structure as shown in FIG. 1 were produced. An anode catalyst layer 12 and a cathode catalyst layer 13 were printed on both sides, respectively, of a polymer electrolyte membrane 11 (Nafion, manufactured by E. I. Du Pont de Nemours & Co. Inc. in the U.S.) capable of selectively transporting hydrogen ions and having a thickness of 20 μm. These catalyst layers contained platinum having an average particle size of 3 nm carried on acetylene black as a catalyst. The weight ratio of acetylene black to platinum was 70:30. For producing separators, a plate of glassy carbon baked at 200° C. was subjected to a blast treatment to form gas flow channels and cooling water flow channels thereon. Gaskets 22 and 23 were made of polypropylene.

The characteristics of the resultant fuel cells were evaluated by measuring the voltage of the fuel cells after 2000 hour operation. The results of the evaluation are shown in Table 1 in which the cell voltage after the 2000 hour operation is expressed as a value relative to the initial cell voltage which is defined as 100.

### COMPARATIVE EXAMPLE

For comparison, a fuel cell was produced in the same manner as in Example 1 except for the use of a conventional current collector comprising a carbon fiber and an insulating binder. The carbon fiber was a polyacrylonitrile-type fiber and the insulating binder was phenol resin. The characteristics of this fuel cell were evaluated in the same manner as in Example 1, and the ratio of the cell voltage after 2000 hour operation to the initial cell voltage was 85.

TABLE 1

| | | Mixing ratio (wt %) | | | | | | | |
|---|---|---|---|---|---|---|---|---|---|
| | | Carbon fiber | | Pulp | | Characteristics | | | |
| | | Water | Water | Water | Water | of current collector | | | |
| | Kind of | repelling | repelling | repelling | repelling | | Resistance | | Cell |
| | carbon | treatment | treatment | treatment | treatment | Weight | value | Thickness | voltage |
| Example | fiber | (Partial) | (Whole) | (Partial) | (Whole) | (g/m²) | (mΩ · cm²) | (μm) | (ratio) |
| 1 | PAN | 85 | — | 15 | — | 90 | 4 | 200 | 98 |
| 2 | PAN | — | 85 | 15 | — | 90 | 5 | 200 | 96 |
| 3 | PAN | 85 | — | — | 15 | 88 | 5 | 198 | 94 |
| 4 | PAN | — | 85 | — | 15 | 89 | 4 | 199 | 95 |
| 5 | PAN | 60 | — | 40 | — | 91 | 10 | 170 | 87 |
| 6 | PAN | 70 | — | 30 | — | 92 | 8 | 185 | 92 |
| 7 | PAN | 90 | — | 10 | — | 90 | 1 | 208 | 99 |
| 8 | PAN | 90 | — | 10 | — | 88 | 1 | 206 | 98 |
| 9 | Phenol | 85 | — | 15 | — | 90 | 5 | 210 | 98 |
| 10 | Phenol | — | 85 | 15 | — | 91 | 5 | 210 | 97 |
| 11 | Phenol | 85 | — | — | 15 | 92 | 4 | 210 | 98 |
| 12 | Phenol | — | 85 | — | 15 | 89 | 5 | 211 | 99 |
| 13 | Pitch | 85 | — | 15 | — | 91 | 4 | 195 | 99 |
| 14 | Pitch | — | 85 | 15 | — | 92 | 4 | 196 | 99 |
| 15 | Pitch | 85 | — | — | 15 | 90 | 4 | 195 | 97 |
| 16 | Pitch | — | 85 | — | 15 | 89 | 4 | 195 | 98 |
| 17 | Rayon | 85 | — | 15 | — | 87 | 5 | 198 | 95 |
| 18 | Rayon | — | 85 | 15 | — | 91 | 6 | 199 | 97 |
| 19 | Rayon | 85 | — | — | 15 | 90 | 6 | 198 | 98 |
| 20 | Rayon | — | 85 | — | 15 | 92 | 5 | 198 | 98 |

Table 1 clearly indicates that the fuel cells comprising the current collectors of the present invention have favorable characteristics regardless of the kind of the carbon fibers. The greater the amount of carbon fiber becomes, the lower the resistance value of current collector becomes. Also, no clear difference is found between applying the water-repelling treatment to the current collector partially and wholly.

The use of hemp pulp or cotton pulp in place of Manila hemp pulp also produced similar results. Further, the use of a mixture of Manila hemp pulp (70 wt %) and polyester fiber (30 wt %) enhanced the strength of the resultant current collector, thereby making the current collector easy to handle.

### EXAMPLE 21-28

In these examples, a carbon fiber and a pulp were mixed and formed into a sheet, and the sheet was subsequently caused to carry fluorocarbon resin particles and carbon particles, to produce a current collector.

As shown in Table 2, various kinds of carbon fibers were used. A carbon fiber and Manila hemp pulp were mixed at various ratios and the resultant mixture was formed into a sheet. The sheet was immersed into a colloidal carbon dispersion having a specific gravity of 1.15 and containing 1 wt % polytetrafluoroethylene dispersion (POLYFLON D-1, manufactured by DAIKIN INDUSTRIES LTD.). The sheet was then pressurized and dried by passing it through between heating rollers of 100° C. As a result, the sheet was caused to carry carbon particles and fluorocarbon resin particles, to produce a current collector. The resistance value of the current collector was measured in the same manner as in Example 1. The carbon fibers used in these examples had the same length, volume resistivity and diameter as those of Example 1, and the sizing agent was also the same as that of Example 1.

Using current collectors produced in the above manner, fuel cells were produced, and the characteristics of the fuel cells were evaluated in the same manner as in Example 1. Table 2 indicates that the fuel cells comprising any of the current collectors of these examples have favorable characteristics in comparison with the comparative example.

TABLE 2

| | | | | Amount of | Characteristics | | | |
|---|---|---|---|---|---|---|---|---|
| | | Mixing ratio | | carbon | of current collector | | | |
| | Kind of | (wt %) | | particles | | Resistance | | Cell |
| | carbon | Carbon | | carried | Weight | value | Thickness | voltage |
| Example | fiber | fiber | Pulp | (wt %) | (g/m²) | (mΩ· cm²) | (μm) | (ratio) |
| 21 | PAN | 85 | 15 | 10 | 95 | 3 | 198 | 98 |
| 22 | PAN | 60 | 40 | 12 | 93 | 8 | 188 | 96 |
| 23 | PAN | 70 | 30 | 11 | 91 | 7 | 190 | 95 |
| 24 | PAN | 90 | 10 | 10 | 90 | 1 | 201 | 100 |
| 25 | PAN | 90 | 10 | 10 | 92 | 1 | 202 | 100 |
| 26 | Phenol | 85 | 15 | 9 | 91 | 4 | 200 | 99 |
| 27 | Pitch | 85 | 15 | 11 | 88 | 3 | 197 | 100 |
| 28 | Rayon | 85 | 15 | 10 | 90 | 3 | 203 | 99 |

### EXAMPLE 29

A current collector produced in the same manner as in Example 21 was further pressurized by passing it through between press rollers. As a result, the thickness of the current collector was reduced from 198 Am to 140 μm, and the surface smoothness thereof was improved in comparison with that before the pressurization. Using this current collector, a fuel cell was produced, and the characteristics of the fuel cell were evaluated in the same manner as in Example 1. The ratio of the cell voltage after 2000 hour operation turned out to be 99. Also, since the surface smoothness of the current collector was superior to that of Example 21, positioning of the current collector was facilitated in fabricating the fuel cell.

### EXAMPLE 30

A current collector produced in the same manner as in Example 23 was immersed in an aqueous dispersion of 0.5 wt % polytetrafluoroethylene such that the current collector was caused to further carry polytetrafluoroethylene. Subsequently, the current collector was pressurized by passing it through between press rollers of 100° C. to heighten the density of the current collector (sheet). As a result, the thickness of the resultant current collector was reduced from 190 μm to 120 μm, and the surface smoothness thereof was improved in comparison with that before the pressurization. Using this current collector, a fuel cell was produced, and the characteristics of the fuel cell were evaluated in the same manner as in Example 1. The ratio of the cell voltage after 2000 hour operation turned out to be 98. Also, since the surface smoothness of the current collector was superior to that of Example 23, positioning of the current collector was facilitated in fabricating the fuel cell.

### EXAMPLE 31

With a high-pressure mercury lamp used as a light source, a current collector produced in the same manner as in Example 23 was irradiated with ultraviolet rays and was subjected to an ozone treatment. Using this current collector, a fuel cell was produced, and the characteristics of the fuel cell were evaluated in the same manner as in Example 1. The ratio of the cell voltage after 2000 hour operation turned out to be 99.

### EXAMPLE 32

A current collector produced in the same manner as in Example 23 was subjected to a plasma treatment under an argon gas atmosphere. Using this current collector, a fuel cell was produced, and the characteristics of the fuel cell were evaluated in the same manner as in Example 1. The ratio of the cell voltage after 2000 hour operation turned out to be 98.

### EXAMPLE 33

With a high-pressure mercury lamp used as a light source, a carbon fiber and a pulp used in Example 23 were irradiated with ultraviolet rays and were subjected to an ozone treatment. Using the resultant carbon fiber and pulp, a current collector was produced in the same manner as in Example 23. Further, using this current collector, a fuel cell was produced, and the characteristics of the fuel cell were evaluated in the same manner as in Example 1. The ratio of the cell voltage after 2000 hour operation turned out to be 98.

### EXAMPLE 34

A carbon fiber and a pulp used in Example 23 were subjected to a plasma treatment under an argon gas atmosphere. Using the resultant carbon fiber and pulp, a current collector was produced in the same manner as in Example 23. Further, using this current collector, a fuel cell was produced, and the characteristics of the fuel cell were evaluated in the same manner as in Example 1. The ratio of the cell voltage after 2000 hour operation turned out to be 98.

As described above, the present invention can provide a current collector for a fuel cell having excellent gas permeability and mechanical strength, small electrical resistance and improved surface water-repellency with a simple and inexpensive production method. Thus, the present invention can provide a current collector for a fuel cell having excellent cell characteristics.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A current collector for a fuel cell which is composed of a sheet comprising a carbon fiber that is at least partially water-repellent and a pulp that is at least partially conductive and water-repellent.

2. The current collector for a fuel cell in accordance with claim 1, wherein said sheet has a weight in a range of 10 to 300 g/m².

3. The current collector for a fuel cell in accordance with claim 1, wherein said carbon fiber is a polyacrylonitrile-type, phenol-type, pitch-type, or rayon-type carbon fiber having a length of 2 to 10 mm, a diameter of 20 μm or less, a volume resistivity of 500 μΩ·m or less.

4. A method of producing a current collector for a fuel cell, comprising the steps of:
(1) mixing a carbon fiber and a pulp and forming the mixture into a sheet; and
(2) causing said sheet to carry fluorocarbon resin particles and carbon particles at least partially, thereby to form a current collector composed of the sheet comprising the carbon fiber that is at least partially water-repellent and the pulp that is at least partially conductive and water-repellent.

5. The method of producing a current collector for a fuel cell in accordance with claim 4, further comprising the step of applying pressure to said sheet to heighten the density of said sheet.

6. The method of producing a current collector for a fuel cell in accordance with claim 4, further comprising the step of subjecting said sheet to ultraviolet rays radiation, ozone treatment or plasma treatment.

7. The method of producing a current collector for a fuel cell in accordance with claim 4, further comprising the step of subjecting said carbon fiber and said pulp to ultraviolet rays radiation, ozone treatment or plasma treatment before mixing them and forming the mixture into a sheet.

8. A method of producing a current collector for a fuel cell, comprising the steps of:
(1) causing a carbon fiber and a pulp to carry fluorocarbon resin particles and carbon particles at least partially; and
(2) mixing said carbon fiber and said pulp carrying said fluorocarbon resin particles and said carbon particles and forming the mixture into a sheet, thereby to form a current collector composed of the sheet comprising the carbon fiber that is at least partially water-repellent and the pulp that is at least partially conductive and water-repellent.

9. The method of producing a current collector for a fuel cell in accordance with claim 8, further comprising the step of applying pressure to said sheet to heighten the density of said sheet.

10. The method of producing a current collector for a fuel cell in accordance with claim 8, further comprising the step of subjecting said sheet to ultraviolet rays radiation, ozone treatment or plasma treatment.

11. The method of producing a current collector for a fuel cell in accordance with claim 8, further comprising the step of subjecting said carbon fiber and said pulp to ultraviolet rays radiation, ozone treatment or plasma treatment before causing them to carry said fluorocarbon resin particles and said carbon particles.

12. A membrane electrode assembly comprising a polymer electrolyte membrane, a catalyst layer disposed on each side of said polymer electrolyte membrane, and the current collector of claim 1 disposed outside said catalyst layer.

13. A fuel cell comprising the membrane electrode assembly of claim 12.
